(19) United States
(12) Patent Application Publication
(10) Pub. No.: US 2008/0192179 A1
(43) Pub. Date: Aug. 14, 2008

(54) LIGHT EMISSION DEVICE AND DISPLAY USING THE SAME

(75) Inventors: Jung-Ho Kang, Yongin-si (KR); Seung-Joon Yoo, Yongin-si (KR); Zin-Min Park, Yongin-si (KR); Su-Kyung Lee, Yongin-si (KR); Won-Il Lee, Yongin-si (KR)

Correspondence Address: CHRISTIE, PARKER & HALE, LLP, PO BOX 7068, PASADENA, CA, 91109-7068, US

(73) Assignee: SAMSUNG SDI CO., LTD., Suwon-si (KR)

(21) Appl. No.: 11/854,723

(22) Filed: Sep. 13, 2007

(30) Foreign Application Priority Data
Feb. 12, 2007 (KR) 10-2007-0014418

(51) Int. Cl. G02F 1/13357; H01J 1/62

(52) U.S. Cl. 349/69; 313/503

(57) ABSTRACT

A light emission device is provided having a first substrate and a second substrate facing the first substrate. An electron emission unit is provided on the first substrate. A light emission unit is provided on the second substrate. The light emission unit includes red, green, and blue phosphor layers and includes an anode electrode formed over the red, green, and blue phosphor layers. The light emission unit satisfies at least one of the following conditions: 0.7<(t_{R}/Φ_{R})/(t_{B}/Φ_{B})<2.2, or 0.5<(t_{G}/Φ_{G})/(t_{B}/Φ_{B})<2, where t_{R}, t_{G}, and t_{B} are thicknesses of the red, green, and blue phosphor layers, respectively, and where Φ_{R}, Φ_{G}, Φ_{B} are mean diameters of the particles of the red, green, and blue phosphor layers, respectively.

### CROSS-REFERENCE TO RELATED APPLICATION

This application claims priority to and the benefit of Korean Patent Application No. 10-2007-0014418, filed on Feb. 12, 2007, in the Korean Intellectual Property Office, the entire content of which is incorporated herein by reference.

### BACKGROUND OF THE INVENTION

1. Field of the Invention

The present invention relates to a light emission device with improved white color temperature, and a display using the light emission device as a light source.

2. Description of Related Art

Generally, a flat panel display is slimmer than a cathode ray tube, which has a large volume and requires a high voltage. The flat panel display is driven with a lower voltage compared with the cathode ray tube. A field emission display and a vacuum fluorescent display are well known as flat panel displays.

The field emission display includes a cathode substrate on which an electron emission unit for emitting electrons is provided and an anode substrate on which a light emission unit is formed. The light emission unit emits light during energy absorption and excitation resulting from the collision of the electrons emitted from the electron emission unit with phosphor layers.

The light emission unit includes red, green, and blue phosphor layers, a metal reflective layer covering the phosphor layers, and a black layer that is formed between the phosphor layers to improve a screen contrast.

The reflective layer is applied with a voltage higher than that applied to the cathode substrate to accelerate the electrons toward the anode substrate. The reflective layer functions as a mirror for reflecting the visible light toward the anode electrode after the visible light is emitted from the phosphor layers toward the cathode substrate when the electrons collide with the phosphor layers. The reflective layer further functions to allow the electrons to flow out without being accumulated on the phosphor layers, thereby increasing the service life of the phosphor layers and preventing the arcing generation between the substrates.

When a black body is heated, a color of the black body is changed into other colors (i.e., red color→orange color→yellow color→white color→blue color) as the temperature increases. When heat is applied to the black body at an absolute zero (−273° C.), which is the lowest temperature, electromagnetic waves (radiant waves) are generated. At this point, a light source property is represented as a unit of the absolute temperature. This is called a color temperature that can be expressed as Kelvin, which is abbreviated simply as “K”. The black body is a theoretical standardized object that can completely absorb incident light of all regions and completely reradiate the light. That is, the black body follows the Planck radiation formula as follows:

S(λ,T)=(2hc²/λ⁵)/(e^{hc/kTλ}−1)

where, c is the speed of light, h is Planck's constant, and k is Boltzmann's constant. An intensity of the radiant energy depending on a temperature and wavelength of the black body can be calculated according to the Planck radiation formula. The radiation of the black body is generally used to estimate a temperature of a furnace or a star. Because a radiation distribution function is related to a wavelength (λ) and a temperature (T), a radiant distribution function S(λ) with respect to each wavelength can be estimated if the temperature of the black body is measured. When the radiant distribution function S(λ) is estimated, X, Y, and Z and x and y color coordinates can be measured and thus a temperature T of the black body can be measured using the x and y color coordinates. FIG. 1 shows a locus traced by the black body in a color coordinate as the temperature varies.

A color temperature represented by the above-described display is about 7,000K-8,000K, which is lower than a target color temperature of 10,000K, when an anode voltage of 7 kV is applied.

FIG. 2A, FIG. 2B, FIG. 2C, and FIG. 2D illustrate white, red, green, and blue luminance and color coordinates. FIG. 2A shows a case when phosphor layers are formed through a slurry process. FIG. 2B shows a case when phosphor layers are formed through a slurry process and an aluminum reflective layer is formed on the phosphor layers. FIG. 2C shows a case when phosphor layers are formed through a printing-exposing process. FIG. 2D shows a case when phosphor layers are formed through a printing-exposing process and an aluminum reflective layer is formed on the phosphor layers.

Referring to FIG. 2A and FIG. 2B, it can noted that, when comparing the case when only the phosphor layers are formed through the slurry process with the case when the aluminum reflective layer is formed on the phosphor layers formed through the slurry process, a luminance ratio (R/B) is almost similar but a color coordinate is improved when the aluminum reflective layer is formed.

Referring to FIG. 2C and FIG. 2D, it can be noted that, when comparing the case when only the phosphor layers are formed through the printing-exposing process with the case the aluminum reflective layer is formed on the phosphor layers formed through the printing-exposing process, the color coordinate is improved and the luminance ratio (R/B) increases by 50% when the aluminum reflective layer is formed. However, the forming of the aluminum reflective layer results in the reduction of the blue luminance. The reduction of the blue luminance causes the reduction of the color temperature. For example, the color temperature falls from 12,000K to 7,400K.

### SUMMARY OF THE INVENTION

Exemplary embodiments in accordance with the present invention provide a light emission device that is designed to improve a display quality by optimizing thicknesses of red, green and blue phosphor layers.

Exemplary embodiments in accordance with the present invention also provide a display using the light emission device as a light source.

In an exemplary embodiment of the present invention, a light emission device includes a first substrate and a second substrate facing the first substrate. An electron emission unit is provided on the first substrate. A light emission unit is provided on the second substrate. The light emission unit includes red, green, and blue phosphor layers and an anode electrode formed over the red, green, and blue phosphor layers. In addition, the light emission unit satisfies at least one of the following conditions:

0.7<(t_{R}/Φ_{R})/(t_{B}/Φ_{B})<2.2, or (1)

0.5<(t_{G}/Φ_{G})/(t_{B}/Φ_{B})<2. (2)

In formulas (1) and (2), t_{R} is a thickness of the red phosphor layers, t_{G} is a thickness of the green phosphor layers, t_{B} is a thickness of the blue phosphor layers, Φ_{R} is a mean diameter of the particles of the red phosphor layers, Φ_{G} is a mean diameter of the particles of the green phosphor layers, and Φ_{B} is a mean diameter of the particles of the blue phosphor layers.

In another exemplary embodiment of the present invention, the red, green and blue phosphor layers may satisfy at least one of the following conditions:

0.7<t_{R}/t_{B}<1.3, or (3)

0.7<t_{G}/t_{B}<1.3. (4)

In another exemplary embodiment of the present invention, the anode electrode may include a metal layer located over the red, green, and blue phosphor layers.

In another exemplary embodiment of the present invention, the metal layer may be aluminum.

Alternatively, the anode electrode may include a transparent conductive layer between the second substrate and the red, green, and blue phosphor layers and include a metal layer located over the red, green, and blue phosphor layers.

In another exemplary embodiment of the present invention, the transparent conductive layer may be indium tin oxide and the metal layer may be aluminum.

In another exemplary embodiment of the present invention, the electron emission unit may include a first electrode extending in a first direction on the first substrate, an insulation layer on a surface of the first substrate and covering the first electrode, a second electrode on the insulation layer and extending in a second direction intersecting the first direction, and an electron emission region formed on the first electrode at a region where the first and second electrodes cross each other.

In another exemplary embodiment of the present invention, a display includes the above-described light emission device and a panel assembly that is located in front of the light emission device to display an image by receiving light from the light emission device.

In another exemplary embodiment of the present invention, the panel assembly may be a liquid crystal panel assembly.

### BRIEF DESCRIPTION OF THE DRAWINGS

FIG. 1 is a view illustrating a locus traced by the black body in a color coordinate as the temperature varies.

FIG. 2A, FIG. 2B, FIG. 2C, and FIG. 2D illustrate white, red, green, and blue luminance and color coordinates, wherein FIG. 2A shows a case when phosphor layers are formed through a slurry process, FIG. 2B shows a case when phosphor layers are formed through a slurry process and an aluminum reflective layer is formed on the phosphor layers, FIG. 2C shows a case when phosphor layers are formed through a printing-exposing process, and FIG. 2D shows a case when phosphor layers are formed through a printing-exposing process and an aluminum reflective layer is formed on the phosphor layers.

FIG. 3 is a schematic sectional view of a light emission device according to an exemplary embodiment of the present invention.

FIG. 4 is a partially cut-away perspective view of the light emission device of FIG. 3.

FIG. 5 is an enlarged view of a portion I of FIG. 4.

FIG. 6 is an enlarged view of a portion VI of FIG. 3.

FIG. 7 is a view of a light emission device according to another exemplary embodiment of the present invention.

FIG. 8 is a graph illustrating a white color temperature with respect to (t_{R}/Φ_{R})/(t_{B}/Φ_{B}) in an exemplary embodiment of the present invention.

FIG. 9 is a graph illustrating a white color temperature with respect to (t_{G}/Φ_{G})/(t_{B}/Φ_{B}) in an exemplary embodiment of the present invention.

FIG. 10 is a partially exploded perspective view of a display according to an exemplary embodiment of the present invention.

### DETAILED DESCRIPTION

All of devices that can emit light to an external side are regarded as light emission devices of exemplary embodiments of the present invention. Therefore, all of displays that can transmit information by displaying symbols, letters, numbers, and images are regarded as the light emission devices. The light emission devices may be used as light sources that can provide light to a passive type (non-emissive) display panel.

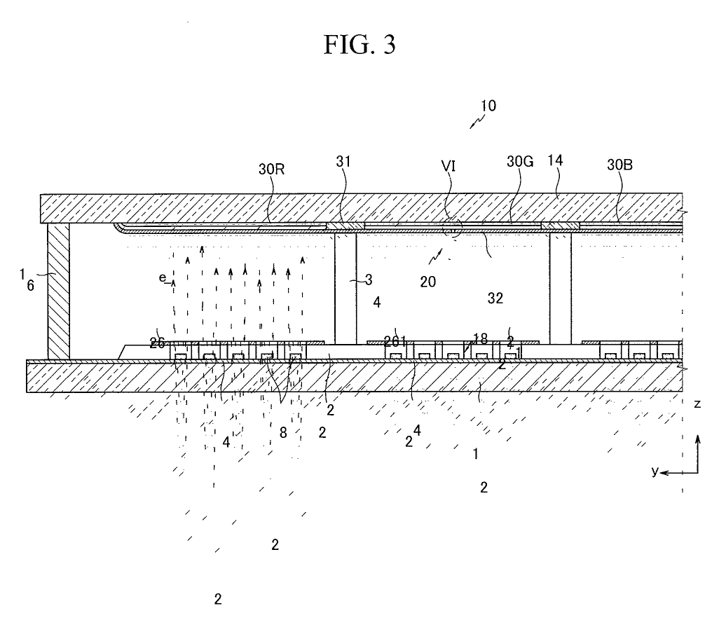

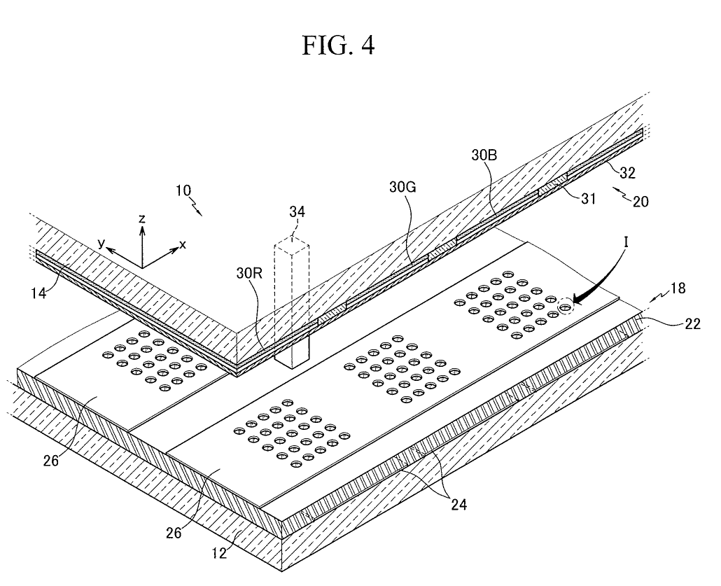

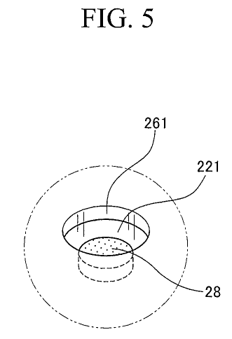

FIG. 3, FIG. 4, and FIG. 5 show a light emission device 10 according to an exemplary embodiment of the present invention. The light emission device 10 includes a vacuum vessel having first and second substrates 12, 14 facing each other in a parallel manner, and in an exemplary embodiment at a predetermined interval. A sealing member 16 is provided between peripheries of the first and second substrates 12, 14 to seal them together and thus form the vacuum vessel. The interior of the vacuum vessel is exhausted during the manufacturing process of the light emission device, thereby being kept to a degree of vacuum of about 10⁻⁶ Torr.

The first and second substrates 12, 14 may be divided into an active area that is surrounded by the sealing member and emits visible light and an inactive area surrounding the active area. An electron emission unit 18 is provided on an inner surface of the first substrate 12 and a light emission unit 20 for emitting the visible light is provided on an inner surface of the second substrate 14.

The electron emission unit 18 includes first and second electrodes 24, 26 that are arranged in stripe patterns crossing each other with an insulation layer 22 interposed therebetween and electron emission regions 28 that are electrically connected to the first electrodes 24 or the second electrodes 26.

When the electron emission regions 28 are formed on the first electrodes 24, the first electrodes 24 function as cathode electrodes applying a current to the electron emission regions 28 and the second electrodes 26 function as gate electrodes for inducing the electron emission by forming an electric field using a voltage difference from the cathode electrodes. Alternatively, when the electron emission regions 28 are formed on the second electrodes 26, the second electrodes 26 function as the cathode electrodes and the first electrodes 24 become the gate electrodes.

In one embodiment, openings 261 and openings 221 are respectively formed in the second electrodes 26 and the insulation layer 22 at respective regions where the first and second electrodes 24, 26 intersect each other, thereby partly exposing the surface of the first electrodes 24. Electron emission regions 28 are located on the first electrodes 24 in the openings 221 of the insulation layer 22. However, the present invention is not limited to this embodiment.

The electron emission regions 28 are formed of a material emitting electrons when an electric field is formed around thereof under a vacuum atmosphere, such as a carbon-based material or a nanometer-sized material. For example, the electron emission regions 28 may includes at least one of materials selected from the group consisting of carbon nanotubes, graphite, graphite nanofibers, diamonds, diamond-like carbon, fullerene C₆₀, silicon nanowires, and a combination thereof. As to a method for forming the electron emission regions 28, a screen-printing process, a direct growth process, a chemical vapor deposition process, or a sputtering process may be applied.

Alternatively, the electron emission regions may be formed in a tip structure made of a molybdenum-based material or a silicon-based material.

The light emission unit 20 includes red, green and blue phosphor layers 30R, 30G, 30B, a black layer 31 arranged between the red, green and blue phosphor layers 30R, 30G, 30B to improve a screen contrast, and a metal layer 32 located over the red, green, and blue phosphor layers 30R, 30G, 30B and the black layer 31.

The metal layer 32 is formed of aluminum (Al) layer covering the red, green, and blue phosphor layers 30R, 30G, 30B. The metal layer 32 functions to enhance the screen luminance by reflecting the visible light, which is emitted from the phosphor layers 30R, 30G, 30B toward the first substrate 12, and reflected back toward the second substrate 14. The metal layer 32 may function as an anode electrode that is an acceleration electrode that receives a high voltage to place the phosphor layers 30R, 30G, 30B at a high electric potential state.

According to an exemplary embodiment of the present invention, thicknesses of the red, green, and blue phosphor layers 30R, 30G, 30B are controlled to improve a color temperature by increasing a luminance of the blue phosphor layer 30B. That is, a ratio of a thickness of the blue phosphor layer 30B to a mean diameter of the particles of the blue phosphor layers 30B or a ratio between the blue phosphor layer 30B and the red phosphor layer 30R or between the blue phosphor layer 30B and the green phosphor layer 30G are controlled to increase the luminance of the phosphor layer.

Specifically, it has been noted that a maximum light emission luminance can be obtained when t_{B}/Φ_{B} (where, t_{B} is a thickness of the blue phosphor layers 30B and Φ_{B} is a mean diameter of the particles of the blue phosphor layers 30B) is 1.5-3.

In order to further increase the light emission luminance of the blue phosphor layers 30B over those of the red and green phosphor layers 30R, 30G, the thickness and mean diameter of the particles of the blue phosphor layers 30B satisfy at least one of the following formulas (1) or (2):

0.7<(t_{R}/Φ_{R})/(t_{B}/Φ_{B})<2.2; (1)

0.5<(t_{G}/Φ_{G})/(t_{B}/Φ_{B})<2. (2)

In formulas (1) and (2), t_{R} is a thickness of the red phosphor layers 30R, t_{G} is a thickness of the green phosphor layers 30G, t_{B} is a thickness of the blue phosphor layer 30B, Φ_{R} is a mean diameter of the particles of the red phosphor layers 30R, Φ_{G} is a mean diameter of the particles of the green phosphor layers 30G, and Φ_{B} is a mean diameter of the particles of the blue phosphor layers 30B.

In addition, in order to form the red, green, and blue phosphor layers 30R, 30G, 30B with a uniform thickness of an interlayer (not shown), the thicknesses of the red, green, and blue phosphor layers 30R, 30G, 30B satisfy at least one of the following formulas (3) or (4):

0.7<t_{R}/t_{B}<1.3; (3)

0.7<t_{G}/t_{B}<1.3. (4)

Through formulas (1) through (4), an optimal condition for increasing the luminance of the blue phosphor layers 30B is realized, thereby increasing the white color temperature.

Disposed between the first and second substrates 12, 14 are spacers 34 that are able to withstand compression force applied to the vacuum vessel and to uniformly maintain a gap between the first and second substrates 12, 14.

The light emission device 10 is driven by applying driving voltages or predetermined driving voltages to the first and second electrodes 24, 26 and by applying a positive direct current voltage (anode voltage) of thousands of volts or more to the metal layer 32.

Then, electric fields are formed around the electron emission regions 28 at the pixels where the voltage difference between the first and second electrodes 24, 26 is equal to or greater than the threshold value, and thus electrons are emitted from the electron emission regions 28. The emitted electrons collide with a corresponding portion of the phosphor layer of the relevant pixels by being attracted by the high voltage applied to the metal layer 32 thereby exciting the phosphor layer. A light emission intensity of the phosphor layer for each pixel corresponds to an electron emission amount of the relevant pixel.

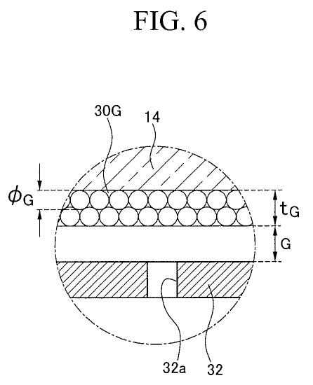

FIG. 6 is an enlarged view of a portion VI of FIG. 3. The interlayer (not shown) is formed on the surfaces of the red, green, and blue phosphor layers 30R, 30G, 30B and the black layer 31 to improve a surface evenness of the metal layer 32 that will be formed through a subsequent process and thus improve reflection efficiency of the metal layer 32.

After the interlayer is deposited on the surfaces of the red, green, and blue phosphor layers 30R, 30G, 30B and the black layer 31, the metal layer having fine holes 32a is formed on the interlayer. Then, the resulting structure is fired at a temperature of 400° C.˜500° C. Then, the interlayer material is vaporized through the fine holes of the metal layer 32. As a result, the metal layer 32 is spaced apart from the surfaces of the red, green, and blue phosphor layers 30R, 30G, 30B and the black layer 31 by a gap G, which in an exemplary embodiment may be predetermined.

As depicted in FIG. 6, the phosphor layers are comprised of a plurality of particles. The particles have varying diameters, with a mean diameter of Φ for each phosphor layer. The phosphor layer has a thickness t. Thus, as depicted in FIG. 6, the green phosphor layer 30G is comprised of a plurality of particles and the plurality of particles have a mean diameter of Φ_{G}. The thickness of the green phosphor layer 30G is t_{G}

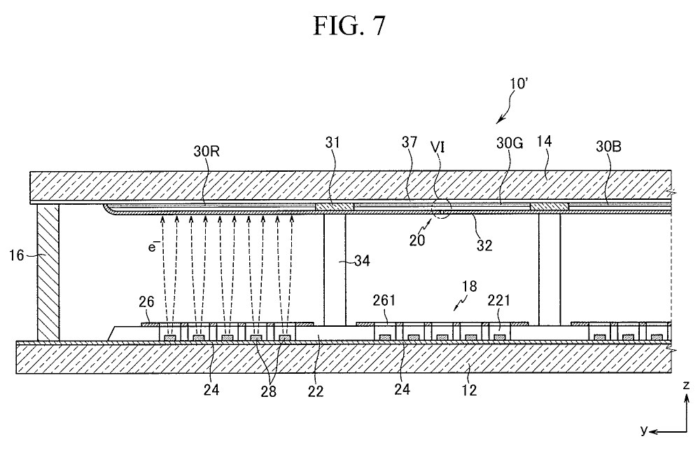

FIG. 7 is a view of a light emission device 10′ according to another exemplary embodiment of the present invention. In FIG. 3 and FIG. 7, like reference symbols indicate like components. The light emission unit 10′ further includes a transparent conductive layer 37 that is an anode electrode located between a second substrate 14 and the phosphor layers 30R, 30G, 30B and black layer 31. The transparent conductive layer 37 may be formed of indium tin oxide (ITO).

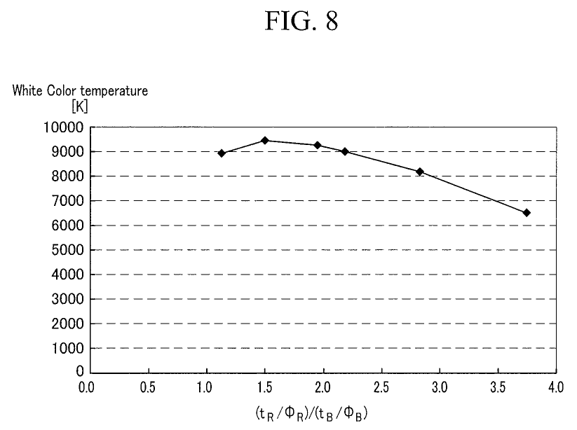

FIG. 8 is a graph illustrating a white color temperature with respect to (t_{R}/Φ_{R})/(t_{B}/Φ_{B}). It can be noted that, under the condition of 0.7<(t_{R}/Φ_{R})/(t_{B}/Φ_{B})<2.2, the white color temperature is 8500K or more and is approximately 10,000K, which is a target color temperature of the light emission device of the exemplary embodiment of the present invention. It can be also noted that, when (t_{R}/Φ_{R})/(t_{B}/Φ_{B}) is greater than 2.2, the white color temperature is steeply reduced.

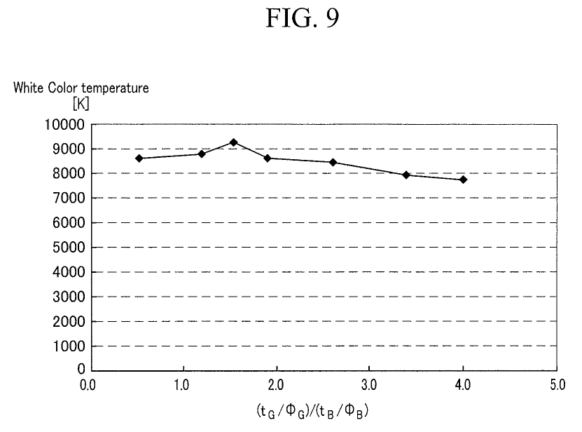

FIG. 9 is a graph illustrating a white color temperature with respect to (t_{G}/Φ_{G})/(t_{B}/Φ_{B}). It can be noted that, under the condition of 0.5<(t_{G}Φ_{G})/(t_{B}/Φ_{B})<2.0, the white color temperature is 8500K or more and is approximately 10,000K, which is a target color temperature of the light emission device of the exemplary embodiment of the present invention.

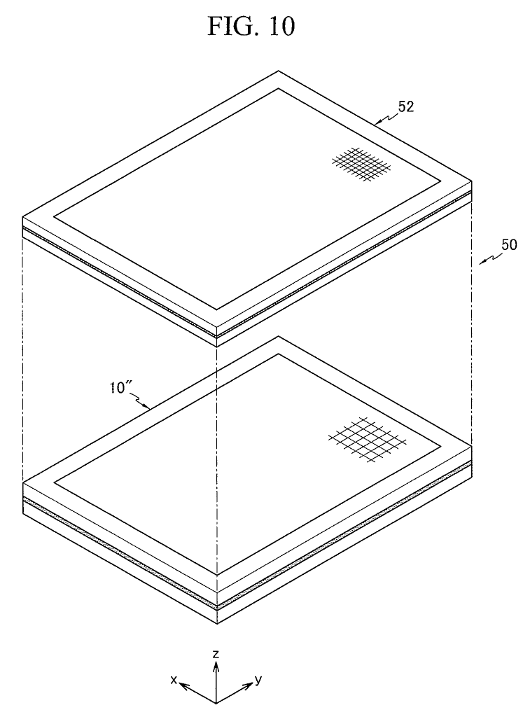

FIG. 10 is a partially exploded perspective view of a display 50 using the above-described light emission device as a backlight unit. The display 50 includes a panel assembly 52 having a plurality of pixels arranged in lines and columns and a light emission device 10″ that is disposed in rear of the panel assembly 52 to emit light toward the panel assembly 52. For convenience, the light emission device 10″ will be referred as a backlight unit hereinafter.

A liquid crystal panel may be used as the panel assembly 52 and, if required, an optical member such as a diffuser plate or a diffuser sheet may be arranged between the panel assembly 52 and the backlight unit 10″.

In this exemplary embodiment, the backlight unit 10″ includes a plurality of pixels arranged in lines and columns. The number of pixels of the backlight unit 10″ is less than the number of pixels of the panel assembly 52. That is, a single pixel of the backlight unit 10″ corresponds to two or more of the pixels of the panel assembly 52. Each pixel of the backlight unit 10″ emits the light in response to a highest gradation among gradations of the corresponding pixels of the panel assembly 52. The backlight assembly 10″ can represent a 2-8 bit gradation at each pixel.

For convenience, the pixels of the panel assembly 52 are referred as first pixels and the pixels of the backlight unit 10″ are referred as second pixels. The first pixels that correspond to one second pixel are referred as a first pixel group.

Describing a driving process of the backlight unit 10″, a signal control unit (not shown) controlling the display panel 50 detects the highest gradation of the first pixel group, operates a gradation required for emitting light from the second pixel in response to the detected high gradation, converts the operated gradation into digital data, and generates a driving signal of the backlight unit 10″ using the digital data. Therefore, each of the second pixels of the backlight unit 10″ emits light by synchronizing with the corresponding first pixel group when the first pixel group displays an image.

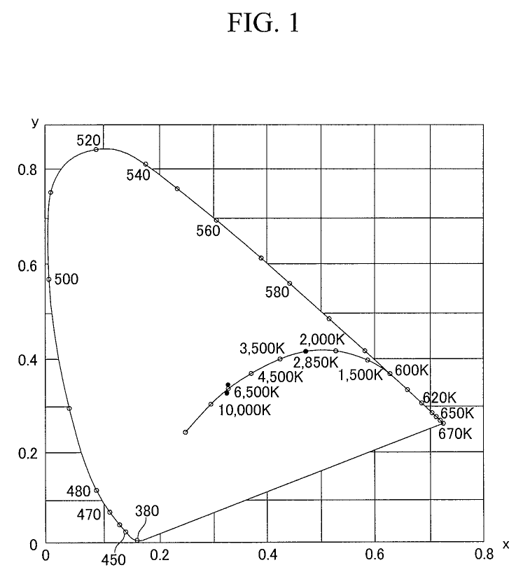

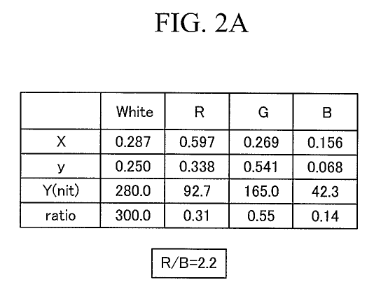

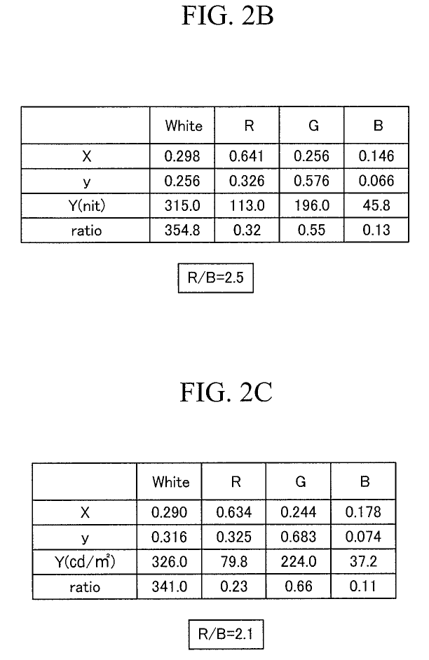

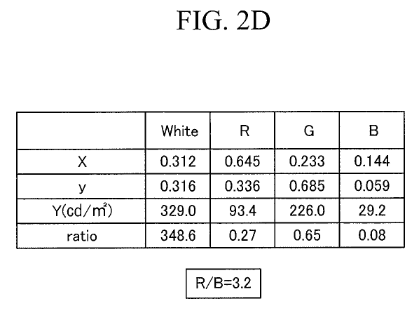

The lines may be defined in a first direction of the display 50, i.e., a horizontal direction (an x-axis in FIG. 10) of the screen of the panel assembly 52 and the columns may be defined in a second direction of the display 50, i.e., a vertical direction (a y-axis of FIG. 1) of the screen of the panel assembly 52.

The number of pixels arranged in each line and each column of the panel assembly 52 may be 240 or more. The number of pixels arranged in each line and each column of the backlight unit 10″ may be 2-99. When the number of pixels arranged in each line and each column of the backlight unit 10″ is greater than 99, the driving of the backlight unit 10″ is complicated and thus the manufacturing cost of the driving circuit increases.

As described above, the backlight unit 10″ is an emissive display panel having a resolution of 2×2 through 99×99. An intensity of the light emission of each pixel is independently controlled to properly emit the light to the corresponding pixels of the panel assembly. Therefore, the display of the present exemplary embodiment can improve the dynamic contrast of the screen, thereby improving the display quality.

In the light emission device according to exemplary embodiments of the present invention, because the thicknesses of the red, green and blue phosphor layers are optimized, the reduction of the luminance of the blue phosphor layers can be prevented and thus the white color temperature increases.

Furthermore, the display employing the light emission device as the backlight unit can enhance the dynamic contrast, thereby improving the display quality thereof. Furthermore, because the power consumption of the backlight unit is reduced, the overall power consumption of the display can be reduced. Furthermore, the display of exemplary embodiments of the present invention can be easily sized to a large size at over 30 inches.

Although exemplary embodiments of the present invention have been described in detail hereinabove, it should be clearly understood that many variations and/or modifications of the basic inventive concept taught herein still fall within the spirit and scope of the present invention, as defined by the appended claims and their equivalents.

What is claimed is:

1. A light emission device comprising:
a first substrate;
a second substrate facing the first substrate;
an electron emission unit on the first substrate; and
a light emission unit on the second substrate,
wherein the light emission unit includes red phosphor layers, green phosphor layers, and blue phosphor layers and includes an anode electrode over the red phosphor layers, the green phosphor layers, and the blue phosphor layers, and the light emission unit satisfies at least one of the following conditions:
0.7<(t_{R}/Φ_{R})/(t_{B}/Φ_{B})<2.2, or 0.5<(t_{G}/Φ_{G})/(t_{B}/Φ_{B})<2,
where, t_{R} is a thickness of the red phosphor layers, t_{G} is a thickness of the green phosphor layers, t_{B} is a thickness of the blue phosphor layers, Φ_{R} is a mean diameter of particles of the red phosphor layers, Φ_{G} is a mean diameter of particles of the green phosphor layers, and Φ_{B} is a mean diameter of particles of the blue phosphor layers.

2. The light emission device of claim 1, wherein the red phosphor layers, the green phosphor layers, and the blue phosphor layers satisfy at least one of the following conditions:
0.7<t_{R}/t_{B}<1.3, or 0.7<t_{G}/t_{B}<1.3.

3. The light emission device of claim 1, wherein the anode electrode is a metal layer.

4. The light emission device of claim 3, wherein the metal layer is aluminum.

5. The light emission device of claim 1, wherein the anode electrode comprises a transparent conductive layer between the second substrate and the red phosphor layers, the green phosphor layers, and the blue phosphor layers, and a metal layer over the red phosphor layers, the green phosphor layers, and the blue phosphor layers.

6. The light emission device of claim 5, wherein the transparent conductive layer is indium tin oxide.

7. The light emission device of claim 5, wherein the metal layer is aluminum.

8. The light emission device of claim 1, wherein the electron emission unit includes:
a first electrode extending in a first direction on the first substrate;
an insulation layer on a surface of the first substrate and covering the first electrode;
a second electrode on the insulation layer and extending in a second direction intersecting the first direction; and
an electron emission region formed on the first electrode at a region where the first electrode and the second electrode cross each other.

9. A display comprising:
a panel assembly for displaying an image; and
a light emission device for emitting light toward the panel assembly,
wherein the light emission device includes:
a first substrate;
a second substrate facing the first substrate;
an electron emission unit on the first substrate; and
a light emission unit on the second substrate,
wherein the light emission unit includes red phosphor layers, green phosphor layers, and blue phosphor layers and includes an anode electrode over the red phosphor layers, the green phosphor layers, and the blue phosphor layers, and the light emission unit satisfies at least one of the following conditions:
0.7<(t_{R}/Φ_{R})/(t_{B}/Φ_{B})<2.2, or 0.5<(t_{G}/Φ_{G})/(t_{B}/Φ_{B})<2,
where, t_{R} is a thickness of the red phosphor layers, t_{G} is a thickness of the green phosphor layers, t_{B} is a thickness of the blue phosphor layers, Φ_{R} is a mean diameter of particles of the red phosphor layers, Φ_{G} is a mean diameter of particles of the green phosphor layers, and Φ_{B} is a mean diameter of particles of the blue phosphor layers.

10. The display of claim 9, wherein the red phosphor layers, the green phosphor layers, and the blue phosphor layers satisfy at least one of the following conditions:
0.7<t_{R}/t_{B}<1.3, or 0.7<t_{G}/t_{B}<1.3.

11. The display of claim 9, wherein the anode electrode is a metal layer.

12. The display of claim 11, wherein the metal layer is aluminum.

13. The display of claim 9, wherein the anode electrode includes a transparent conductive layer between the second substrate and the red phosphor layers, the green phosphor layers, and the blue phosphor layers, and includes a metal layer over the red phosphor layers, the green phosphor layers, and the blue phosphor layers.

14. The display of claim 13, wherein the transparent conductive layer is indium tin oxide.

15. The display of claim 13, wherein the metal layer is aluminum.

16. The display of claim 9, wherein the electron emission unit includes:
a first electrode extending in a first direction on the first substrate;
an insulation layer on a surface of the first substrate and covering the first electrode;
a second electrode on the insulation layer and extending in a second direction intersecting the first direction; and
an electron emission region formed on the first electrode at a region where the first electrode and the second electrode cross each other.

17. The display of claim 9, wherein the panel assembly is a liquid crystal panel assembly.
